(19) United States
(12) Patent Application Publication
(10) Pub. No.: US 2003/0063724 A1
(43) Pub. Date: Apr. 3, 2003

(54) Utilitarian item for use with remote access system

(76) Inventor: Joao Amarall, Miami, FL (US)

Correspondence Address: David W. Barman, 1101 NE 176 Terrace, North Miami Beach, FL, 33162, US

(21) Appl. No.: 09/968,444

(22) Filed: Oct. 1, 2001

(51) Int. Cl. H04M 15/00

(52) U.S. Cl. 379/114.2; 379/114.01; 379/114.06; 379/114.26

(57) ABSTRACT

A utilitarian item for use with a remote access system is herein disclosed and described.

### FIELD OF THE INVENTION

The present invention is for creating a utilitarian item for use with a remote access system.

More particularly, the current invention is a utilitarian item, which can be printed with telecommunications access information.

### BACKGROUND OF THE INVENTION

The telecommunications industry has experienced a growth over the last ten years that has surpassed that of the previous one hundred years. The consumer is able to choose from a vast array of products and services. One area of particular interest is telephone calling cards. The calling card has been around for many years. A relatively new variation of this service is a pre-paid calling card. When a consumer wishes to limit their obligation and outlay of cash, they can choose this service. They purchase a card for a fixed dollar amount. The card is printed with information that provides an access number and a code that allows the central transmission computer to establish an account and monitor the airtime used. Usually, the standard method of use is when the airtime is depleted; the consumer discards the card and purchases another. Some cards have allowed consumers the option of adding money to their account, thus eliminating the need for multiple purchases.

There are numerous patents covering the methods and products for the pre paid calling cards. U.S. Pat. Nos. 6,222,915; 6,028,920; and 5,909,486 are incorporated herein by reference. U.S. Pat. No. 6,028,920 recognizes the need for the consumer to do more with the card than throw it away. It provides for a debit account which can be used for phone and consumer services. The common factor of the currently issued patents is the card. The consumers have cards that perform many functions. There does not currently exist any method for the consumer to use access information in any means beyond the card.

It is an object of the current invention to provide for consumer access information to be provided for in a utilitarian means.

It is a further object of the invention that the utilitarian means be that of a useful consumer item.

### DETAILED DESCRIPTION OF THE PREFERRED EMBODIMENT

The current invention relates to a utilitarian item, which is manufactured and printed with the access information necessary for a consumer to remotely access a central communication system. This can be a telecommunications system, a debit system, or any other system, which provides individualized consumer account service. The use of a utilitarian item in advertising specialties is not new. The current invention would allow an advertiser to use the utilitarian item of an advertising specialty, and tie it to a consumer account. A company could even use the current invention to give away a pre paid account as a method of both advertising and consumer reward.

Another embodiment would be for a pre paid phone service to give away a utilitarian item with an initial amount already deposited into an account in an attempt to advertise and draw new users to the service. Additionally, a pre paid phone service could use the utilitarian item to reward current customers.

A utilitarian item is any item, which can perform a function or have a useful purpose beyond that of providing the access information. Utilitarian items can include, but are not limited to: pens, pencils, key chains, lighters, calendars, coasters, cups, mugs, drink glasses, checkbook covers, book covers, binders, placemats, magnets, and other such consumer items. The utilitarian item would contain a telephone access number and a personalized consumer access code. The item would be used by having the consumer dial the access number printed on their item, enter an personal access code, and have access to the telecommunications system. This item can be used to replace the currently used pre paid phone cards. All of the information would be printed on the utilitarian item. The consumer than could use the telecommunications system until the pre paid amount were exhausted. In those systems where an account can be replenished with additional monies, the consumer would have the option to perform said replenishment. If the consumer does not wish to continue the account, he does not create immediate waste product. The consumer is left with a utilitarian item, which still can perform a useful function. Generally, the invention has been described in its preferred form or embodiment with some degree of particularity, it is to be understood that this description has been given only by way of example and that numerous changes in the details of construction, fabrication and use, including the combination and arrangement of parts, may be made without departing from the spirit and scope of the invention.

I claim:

1. A utilitarian item, which is printed with access information by which a consumer can remotely access a consumer account.

2. The utilitarian item of claim 1 where said access information comprises a telephone number used to reach a central telecommunications station.

3. The utilitarian item of claim 1 where said access information further comprises a personal access code.

4. The utilitarian item of claim 2 where said telecommunication station is used to access a prepaid phone account.

5. The utilitarian item of claim 4 where said access information further comprises personal access code for a prepaid phone account.

6. The utilitarian item of claim 1 where said utilitarian item further contains advertising information.

7. The utilitarian item of claim 1 where said utilitarian item is a pen.

8. The utilitarian item of claim 1 where said utilitarian item is a pencil.

9. The utilitarian item of claim 1 where said utilitarian item is a keychain.

10. The utilitarian item of claim 1 where said utilitarian item is a cup, mug or drinking glass.
